(19) United States
(12) Patent Application Publication
(10) Pub. No.: US 2021/0198087 A1
(43) Pub. Date: Jul. 1, 2021

(54) Erectable crawler crane safety barrier

(71) Applicant: Daniel Carl Mastrosimone, Riverview, FL (US)

(72) Inventor: Daniel Carl Mastrosimone, Riverview, FL (US)

(21) Appl. No.: 16/726,886

(22) Filed: Dec. 25, 2019

(51) Int. Cl. B66C 15/00; B62D 33/06; B60R 19/02

(52) U.S. Cl. CPC B66C 15/00; B60R 19/023; B62D 33/06

(57) ABSTRACT

A crane barrier access warning system suspended by four or more pinned adjustable telescoping supports, which extend outward from a cranes lower car body between the tracks. One of the telescoping members end inserts into a mounting frame, which comprises of other pinned adjustable telescoping components, so that it can be fitted to the frame or track beams. This entire safety barrier system is erected without tools. The components that form the actual safety barrier surrounds the whole crane and are suspended from it so that the safely barrier moves with the crane. Suspension components are adjustable through their pinned telescoping members so that the invention can fit different sized cranes. All the parts can be separated and fully retracted for shipping or storage.

### BACKGROUND OF THE INVENTION

Unless otherwise indicated herein, the arrangement of materials described in this section are not prior art to the claims in this application and are not admitted to be prior art by inclusion in this section.

Safety is a major concern for operators and contractors using construction equipment. For example, since 1992, the Bureau of Labor Statistics has tracked fatal workplace accidents in its Census of Fatal Occupational Injuries (CFOI). As the CFOI details, the number of worker fatalities has ranged between 4,551 per year and 6,632 per year from 1992 to 2012. A significant percentage of these deaths occur as a result of accidents involving construction equipment. Also, the Code of Federal Regulations, at Title 29 C.F.R. Section 1926.1424, addresses swing work area controls where the equipment's rotating superstructure (whether permanently or temporarily mounted) poses a reasonably foreseeable risk of (i) striking and injuring an employee or (ii) pinching/crushing an employee against another part of the equipment or another object.

One reason for accidents is that workers on the ground, or innocent bystanders, are struck by construction equipment or caught between and pinched or crushed by pieces of construction equipment. This can occur when a construction vehicle operator's vision is reduced by a blind area.

One prior non patented art method for a crawler cranes safety swing radius barrier has been putting four traffic cones or other supports around (but not connected to) the crawler crane, and then tying plastic caution, or danger ribbon to each cone. Another non patented method is to place wood or metal barriers all the way around a crawler crane. These methods however become cumbersome, time consuming, and an inconvenience when it comes time to move the crawler crane to a different location. The barrier has to be physically moved in pieces as well. Also, high winds make it nearly impossible to keep the ribbon, cones and barriers in place and intact. Another non patented prior art safety barrier method for crawler cranes is to weld a channel iron holder onto each end of the crawler cranes track frame end, then insert fitted iron poles or frames into them that stick out far enough to cover the cranes swing radius circumference when plastic danger ribbon is tied to each pole or bracket end. This barrier system moves with the crane. However, common operator carelessness causes the poles or bracket to get broken or bent when crane movement forces them into solid objects. Operators of other machinery have been readily known to destroy them as well. Also welding anything onto a crane alters the manufacturers specifications. And many newer cranes make it difficult or impossible to weld anything in those areas. This current invention avoids, remedies, or attenuates these issues and more.

### BRIEF DESCRIPTION OF THE INVENTION

With the increase of maximum safety consciousness on work place job sites, others have attempted to eliminate the dangers of the operation of heavy equipment and cranes.

One example is U.S. Pat. No. 3,812,978 Roland, et al. This prior art swing radius barrier is acceptable according to O.S.H.A. for cranes that are equipped with outriggers. But this is not a realistically possible safety barrier for a track mounted (crawler) crane.

Other similar examples of prior art are Gehl, U.S. Pat. No. 4,434,901 and Amsinger U.S. Pat. No. 6,102,373. These similar forms of prior art work well. However, they fall short if the cranes upper rotating superstructure is positioned or moved over the side of the tracks. In these instances, these inventions protrude taking up more space beyond the counterweight than necessary. And there may not be enough room for these inventions in every area the crane needs to be positioned at, rendering them non deployable. They also do not alert or prevent a person from getting in between the tracks when the counterweight and rotating superstructure is positioned over the side of the tracks. Therefore, if the upper rotating superstructure were to quickly swing, it may be too late by the time these prior art inventions touch the unauthorized person, and crushing and bodily injury can still result.

Another type of prior art example is Schlueter, U.S. Pat. No. 9,045,881. With this art, a solid metal barrier has the ability to be deployed or retracted by hydraulically actuated cylinders. This invention is entirely capable of preventing unauthorized persons from entering into the swing danger area. However, the art has several limitations. 1) It cannot be installed on an older crane or excavator that hasn't already been manufactured with the necessary hydraulic and electronic technology to support the physical mechanical members of the invention. And doing so would alter and violate the manufacturers specifications. 2) It would require that all manufacturers of rotating upper structure machinery build such machinery to incorporate the Schlueter prior art. 3) With the Schlueter art deployed on an excavator, it would prevent the operator from using the end effector {bucket, ram, or other attachment) up close to the excavators inward short radius without damaging the components of the invention, and would require the operator to retract the barrier, thus defeating the purpose of the invention. Most likely these are the reasons why the Schlueter prior art has not been accepted or predominantly seen in the current field of upper rotating structure construction equipment within the construction industry since its date of patent year 2015.

Another prior art example of a swing radius barrier for a rubber tire crane with outriggers is Chustz et al. patent Ser. No. 10/077,171 This embodiment works well for that type of crane. But cannot be deployed on a track mounted crawler crane lower car body frame. And was not intended for such.

### DETAILED DESCRIPTION OF THE INVENTION

A swing radius barrier designed strictly for track mounted crawler crane car body frames with an upper rotating structure, to prevent bodily harm from the upper rotating structure and damage to surrounding objects by the counterweight. The flexible end to end interconnecting rigid plastic tubing in front and back will not cause bodily harm or damage if it happens to make contact with an object or a person. But is solid enough to hinder and alert approaching employees of the danger area. Signs warning of the danger can also be hung on it as well as the plastic ribbon portion of the barrier on each side. If these flexible members make contact with something in an operator's blind spot. The tightening or breaking of the ribbon/tape, or the loosened condition of it would visually alert the operator. The sum of all the outer swing radius barrier components go all the way around the entire crane, so that unauthorized persons are warned of the danger well in advance instead of after they are already in the danger area like older patented prior art inventions. These outer barrier components being suspended by telescoping extension members made of light weight metal channel tubing are unlike any other prior art. In that they are mounted and erected, telescoping adjustable member sections emanating from the center area of the crane car body frame. This aspect of telescoping sections makes the current art adequately capable of fitting more than one size and type of crawler crane without altering the cranes manufacturer specifications.

### BRIEF DESCRIPTION OF THE DRAWINGS

FIG. 1 Is a bottom view depicting a crawler crane car body with the current invention erected onto it.

FIG. 2 Is a side cut away view depicting the current inventions mounting frame and how it mounts around the crawler cranes car body track beam. The track is cut away exposing the square beam.

FIG. 3 This is a side view depicting the hinge on each of the two telescoping extension portions of the barrier supports.

FIG. 4 Is a front view of the telescoping adjustable mounting frame as it is mounted onto a crawler cranes car body track beam.

FIG. 5 Is a front view depicting the front and rear barrier components and supporting pendant cable.

FIG. 6 Depicts four views of one of the two adjustable telescoping sectional extensions.

FIG. 7 Depicts a side view of one of two adjustable telescoping sectional extensions unassembled.

FIG. 8 Depicts a top view of one of two adjustable telescoping sectional extensions assembled.

FIG. 9 Depicts a side view of one of two adjustable telescoping sectional extensions assembled

### DETAILED DESCRIPTION OF THE DRAWINGS

It is to be duly noted that the identified sections and components in each drawing view refer to a set of each to comprise the entire invention. A front and back set, and left and right sides. In order to present orderly neat drawings, it was necessary to present them in this manner. Most of the terms here in are commonly known by persons familiar with the field of the art.

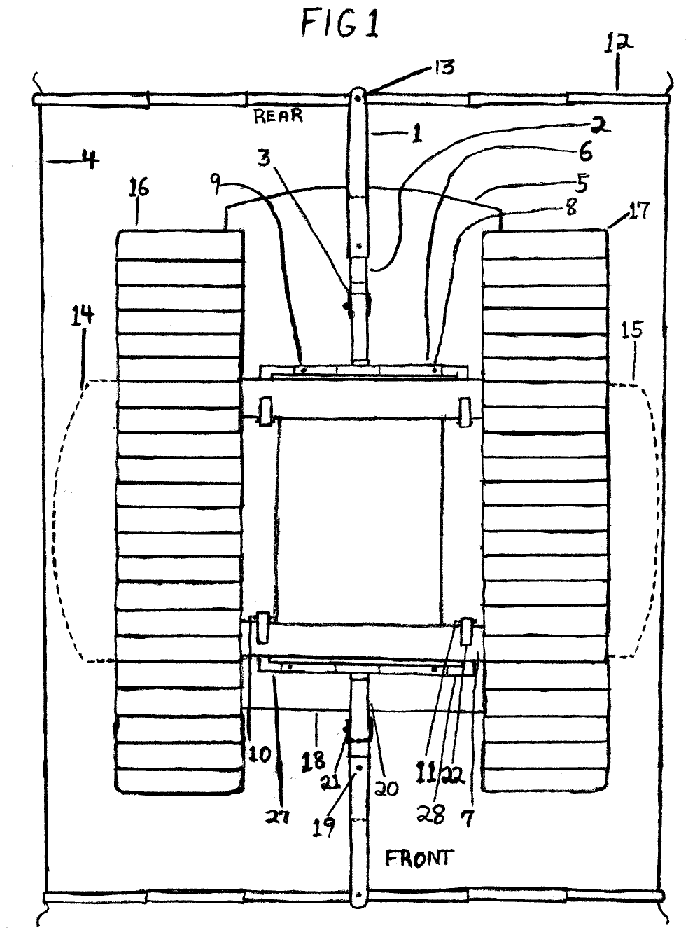

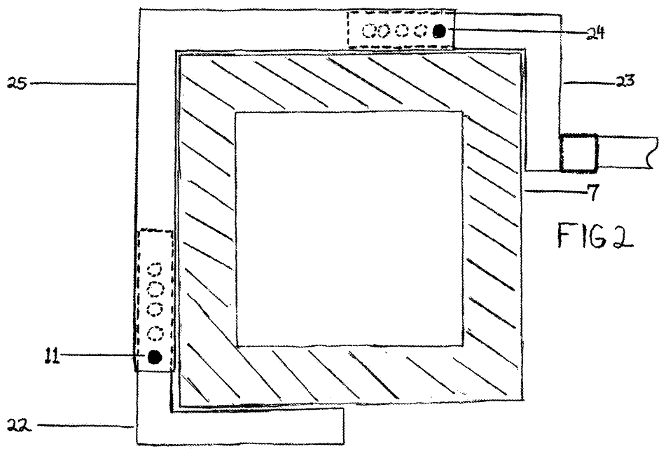

Referring to FIG. 1 is shown a crawler crane tracks and car body from a bottom view, 1 depicts one section of the invention's extension supports that telescope fitted over 2, the mid support and is pinned off at the proper hole setting, while 2 points to the mid portion of the support which comprises of half of the hinge 3 (see FIG. 3). 4 shows the plastic ribbon, tape, or fiber rope which comprises the side barrier portion. The opposite track side barrier is the same which is not labeled. S depicts the counter weight portion of the upper rotating super structure that is the farthest outer end of the swing radius, 6 depicts the current inventions mounting frame center section member. 7 depicts one of the two crane car body track beams. The opposite track beam is not labeled. The mounting frame is pinned to the proper adjustable hole settings with pins 8 and 9. Two other size adjustment pins on the mounting frame are depicted by 10 and 11 on the opposite side mounting frame. Two other adjustment pins are not visible in this view (see FIG. 2). The front mounting frame not labeled is exactly the same as the depicted rear 6. 12 shows a rigid plastic tubing section as it is inserted end to end into the others to comprise the total width of the front barrier, and is attached at the center of the telescoping extension support 1 by a pin 13 adjoining the two in a manner that allows the barrier to pivot at this connection point. The front barrier not labeled is exactly the same. 14 and 15 depict the upper rotating super structure counter weight right and left positions when it is over the side of the tracks and shows its approximate distance from the right and left ribbon or rope barriers 16 and 17 depicts the crawler cranes tracks as they are connected to the car body positioned in between. 18 points to the front portion of the crawler cranes upper rotating structure. 19 on the front invention end depicts the adjustment pin for the telescoping extension members as it is set into the proper hole setting to position the outer rigid plastic tubing barrier to the proper distance of the cranes swing radius. The extension adjustment pin on the rear end is exactly the same. 20 depicts the inner extension support, and its end that makes up the other half of the hinge 3. 21 depicts the pivot pin connecting the two halves of the hinge (also see FIG. 3). 22 depicts one of the four mounting frame adjustable telescoping members as it is fitted to the track beam(s).

FIG. 2 Is a side view cutaway of one of the crawler cranes car body track beams 7, to which the current invention art is fitted. 23 depicts one inner telescoping member of the mounting frame, with its different adjustment holes (dashed lines) approximately one quarter to one half inches apart so the invention can be properly fitted to various sizes of crawler crane car body track beams. 24 depicts the setting adjustment pin. 25 depicts the outer member of the mounting frame possessing one pin hole at each end. 11 depicts the opposite end adjustment pin. And 22 depicts the opposite end inner telescoping member of the mounting frame, and its holes (dashed lines) for larger adjustment settings approximately one quarter to one half inches apart for proper fitting to other crawler crane car body track beams.

FIG. 3 Depicts a side view of one of the two extension hinges seen in FIG. 1, 3, both being exactly the same. 2 depicts one end of the hinge square tubing that fits over a smaller size square tubing end of 20. 21 depicts the pivot pin that attaches the secondary hinge member to the first which also allows the secondary member to move up or down. The dashed line represented by 26 depicts the top portion of 2 that is a square opened space in a manner to allow the necessary upward movement of member 2. The double ended arrows not labeled depicts the allowed radius movement and distance of member 2, while the other dotted line not labeled represents the plain of the hinge when it is fully lowered and in its locked position suspending the rigid plastic tubing barrier in FIG. 1,12 in its normal waist high position.

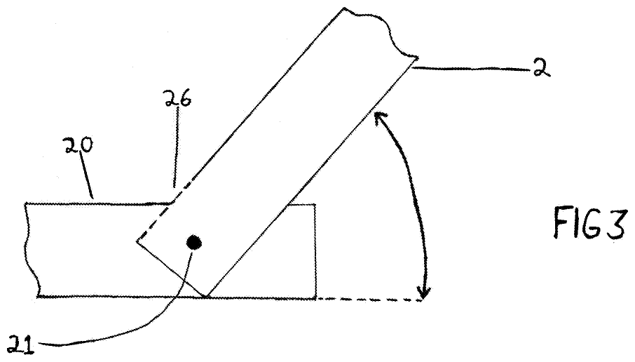

FIG. 4 Depicts a front view of the mounting frame and its center section member 6 as it would be mounted on the crane car body track beam 7, showing four of the current arts six telescoping adjustable members. 23 depicts the top left inner section telescoping member and the outer section member adjustment pin 24. 8 depicts the left horizontal width adjustment pin which holds the left horizontal telescoping section 28 in place. 9 depicts the right horizontal width adjustment pin which holds the right horizontal telescoping section 27 in place. 29 depicts the top right inner section telescoping member, and the outer section member adjustment pin 30. 22 shows the right bottom telescoping adjustable section, and 31 shows the left bottom telescoping adjustable section.

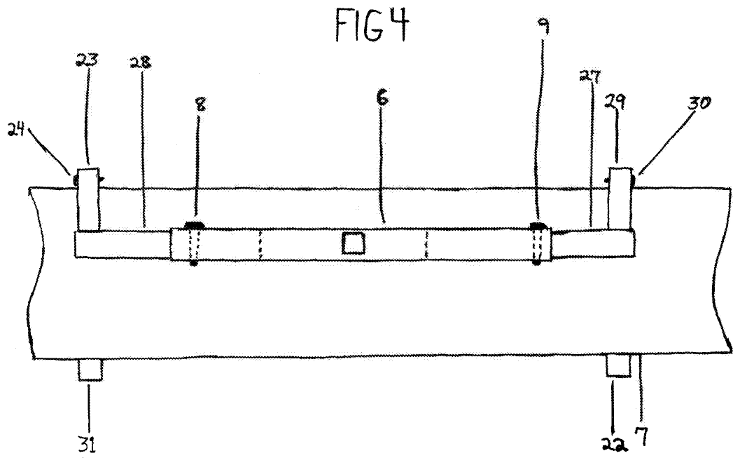

FIG. 5 Is a front view of one of the two barriers showing one to depict both, comprised of 12 representing all the end to end interconnecting rigid plastic tubing section members. 32 depicts the wire, or cable pendant which prevents the rigid plastic tubing from drooping. And 33 depicts the pendant tower which would be part of the top side end of the extension member depicted in FIG. 1, 1.

FIG. 6 Is a top view of the telescoping sections shown separately as they would go together, and their adjustment pin holes. The right section 6 is an extending portion of the mounting frame.

The midsection 2 shows the adjustment holes at the right, and the hinge movement opening on its left end. Section 1 slides over section 2 and would pin at the desired length setting.

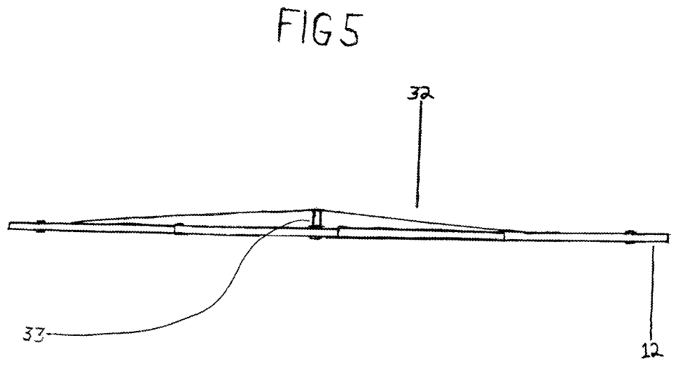

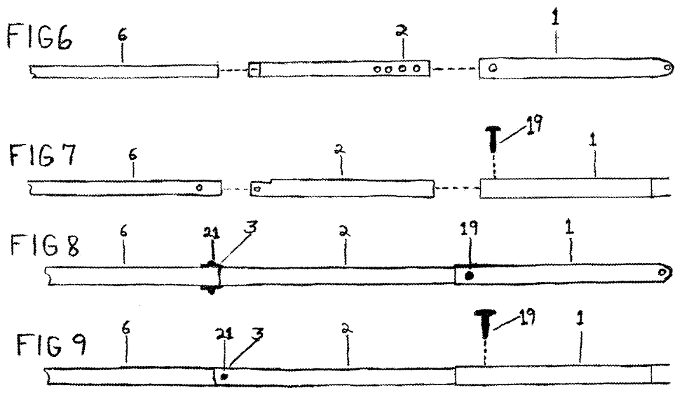

FIG. 7 is a side view of the separated extensions and how they would go together as 6 once again being a portion of the mounting frame, 2 the midsection that pins to 6 forming the locking hinge. Then section 1 slides over the right end of 2 and the pin 19 goes into the hole at the desired length setting.

FIG. 8 Demonstrates a top view of all of the sections properly put together. The right end of 6 is pinned with 21 pivot pin, to the left end of 2 forming the locking hinge 3, and 1 is slid over the right end of 2 and pinned with 19 pin at the desired length.

FIG. 9 is a side view of all the sections properly put together with pivot pin 21 adjoining the right end of 6 and the left end of 2 to form the locking hinge 3. And 1 is slid over the right end of 2 and pinned with the pin 19.

While various aspects and embodiments have been disclosed herein, other aspects and embodiments will be apparent to those skilled in the art. The various aspects and embodiments disclosed herein are for purposes of illustration and are not intended to be limiting.

What is claimed as new:

1. An erectable swing radius safety barrier for crawler cranes, in which one component of it is configured to mount to the front, and another just like it mounts to the back central areas of the crawler cranes car body frame, center counter weight, or track beams by means of their adjustable telescoping sectional members as a mounting frame, in which the extension members comprising of a plurality of other adjustable telescoping components erect onto those said mounting frames, are configured to extend outward from those mounted frames and connect to a plurality of perpendicular and parallel components which go around the entire crawler crane in a square formation at waist height forming the barrier when all the safety barrier components are erected, and also can be removed from the crane car body by a person without tools when the safety barrier is not required to be erected.

2. The erected safety barrier of claim 1, wherein the safety barrier itself surrounds slightly more than all of a circumference defined by a swing radius of a rotating cab structure in a larger square shape, all suspended by telescoping extension sectional members that are erected onto an adjustable mounted frame on the crawler cranes car body frame, beams, or center counter weight

3. The erectable safety barrier of claim 1, and (i) it's attaching adjustable mounting frames, (ii) plurality of adjustable telescoping extension support components for each frame, (iii) Plurality of plastic tubing comprising the perpendicular front and back barriers, and (iii) the use of plastic or fabric danger, caution ribbon, or rope connecting each plastic tubing end, all erectable by a person without tools.

4. The erectable safety barrier apparatus of claim 1, wherein (i) a first portion set of components (front and rear) mount to the crane car body via a manually adjustable frame attachment with holes in it so that it can be pinned at necessary lengths to fit crane car body surface areas with differing dimensions when necessary, and (ii) a second set of components (front and rear) comprising of two or more manually telescoping extension sectional members which each set has a single hinge which allows for an authorized person to manually raise and lower the front or rear barrier up to pass under, or for personnel to prevent being injured by manually raising for escape, (iii) a taught wire or cable affixed to the outer region areas of the rigid plastic tubing that is supported in the center by a slightly higher component to prevent drooping.
